(19) United States
(12) Patent Application Publication
(10) Pub. No.: US 2024/0158312 A1
(43) Pub. Date: May 16, 2024

(54) SYSTEM AND METHOD FOR PRODUCING AMMONIA, UREA, AND UAN

(71) Applicant: ProMachine, Inc., Prior Lake, MN (US)

(72) Inventor: James Prohaska, Prior Lake, MN (US)

(21) Appl. No.: 18/493,202

(22) Filed: Oct. 24, 2023

Related U.S. Application Data
(60) Provisional application No. 63/424,728, filed on Nov. 11, 2022.

(51) Int. Cl. C05C 1/00

(52) U.S. Cl. CPC C05C 1/00

(57) ABSTRACT

A fertilizer production plant is co-located with an ethanol production plant. Low value organic material waste such as corn fiber is gasified to produce hydrogen. Ambient air is separated to produce nitrogen and oxygen. Hydrogen and nitrogen are reacted to produce ammonia. Carbon dioxide generated by the ethanol production plant and the ammonia are reacted to produce urea. The oxygen and ammonia are used to produce ammonium nitrate, and urea and ammonium nitrate are processed to produce area ammonium nitrate (UAN).

### CROSS-REFERENCE TO RELATED APPLICATION(S)

This application claims the benefit of U.S. Provisional Application No. 63/424,728, filed Nov. 11, 2022, and entitled “SYSTEM AND METHOD FOR PRODUCING AMMONIA, UREA, AND UAN,” the disclosure of which is hereby incorporated by reference in its entirety.

### BACKGROUND

Over the past two decades, production of ethanol fuel has grown dramatically, and the United States became the world's largest ethanol producer. Ethanol distillery plants are located in more than half of the states of the United States. Most ethanol produced in the United States comes from corn.

Corn fiber is a low-value stream byproduct that is produced by ethanol plants. Currently this corn fiber stream is combined with protein streams to produce DDGS (Dried Distillers' Grain with Solubles), which is sold to cattle markets. A current trend in the ethanol industry involves separation of the protein from the DDGS to produce a higher value product.

The problem with this approach involves the value of the corn fiber that is left after protein has been removed from DDGS. The resulting lower protein corn fiber stream has very little market value and has proven to be difficult to sell. This negatively affects the overall value of the protein separation process, because the net market value of the two resulting products (high protein feed and low protein corn fiber) is less than the net market value of the original DDGS product.

In addition, the ethanol plant produces excess carbon dioxide, which currently is vented to the atmosphere. Any value the carbon dioxide has is lost, and adding carbon dioxide to the atmosphere has negative ecological effects on the environment.

### SUMMARY

A fertilizer production plant is co-located at an ethanol production plant. Organic material waste (such as corn fiber) and carbon dioxide generated by the ethanol production plant and ambient air are used to produce agricultural fertilizer such as anhydrous ammonia, aqueous ammonia, dried urea, and urea ammonium nitrate (UAN).

### BRIEF DESCRIPTION OF THE DRAWINGS

FIG. 1 is a block diagram showing a fertilizer production system co-located with an ethanol plant to produce fertilizer products from low value feed streams such as corn fiber created in the ethanol distillation process.

FIG. 2 is a flow diagram illustrating production of ammonia fertilizer products from corn fiber.

FIG. 3 is a flow diagram illustrating production of urea fertilizer products from corn fiber.

FIG. 4 is a flow diagram illustrating production of urea ammonia nitrate (UAN) fertilizer products from corn fiber.

### DETAILED DESCRIPTION

Co-Located Ethanol Plant and Fertilizer Plant

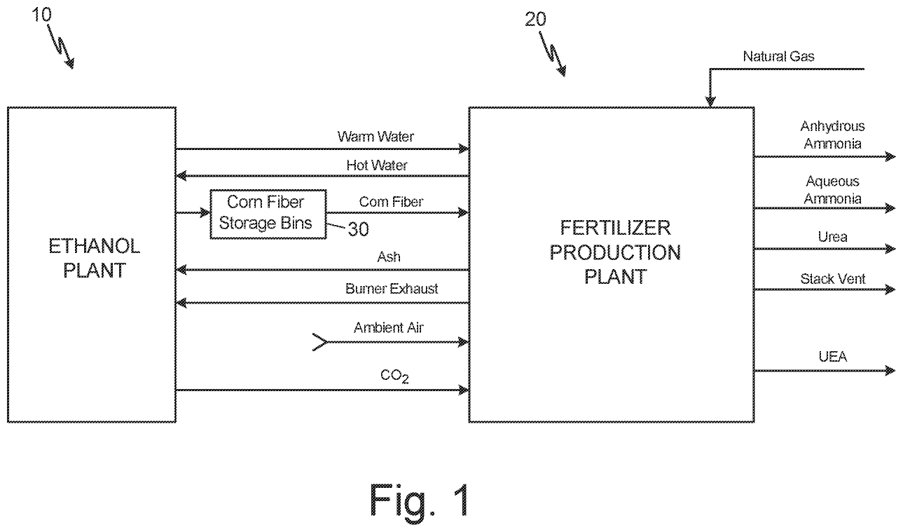

FIG. 1 is a block diagram includes ethanol plant 10, fertilizer production system 12, and corn fiber storage bins 14 which are located so that corn fiber and carbon dioxide (CO2) produced during the ethanol production from ethanol plant 10 can be used by system 12 to produce fertilizer products. The fertilizer products that can be produced include anhydrous ammonia product, aqueous ammonia product, urea product, and urea ammonium nitrate (UAN) product.

Ethanol plant 10 supplies warm water, corn fiber, and CO2 to fertilizer production system 12. Ambient (atmospheric) air is also an input to system 12. Hot water is returned to the ethanol plant 10. Ash and burner exhaust produced in gasification of the corn fiber can be returned to plant 10 for disposal or can be scrubbed and disposed of by fertilize production system 12. Natural gas is also supplied for drying the urea product, and a vent stack is provided for removal of moisture and carbon monoxide from the urea dryer.

The manufacture of agricultural fertilizer (such as ammonia, urea, and urea-ammonium-nitrate products) is performed onsite at ethanol plant 10. Fertilizer production process 12 uses low-value feedstock produced during ethanol production. The low-value feedstock includes corn fiber left over after protein is extracted from the dried distiller's grains, carbon dioxide produced as a by-product of ethanol manufacturing, nitrogen from ambient air, and heat recovered from the exothermic reactions during the creation of ammonia, urea, or UAN products. This fertilizer production process can operate continuously or in batches, and can produce one, two, or all three of the fertilizer products simultaneously.

The entire manufacturing process and storage of the end products ammonia, urea, or UAN is completed onsite at ethanol plant 10. Ammonia, urea, and UAN products can then be sold as-is to various markets. The agricultural market is a primary market, given that these forms of ammonia, urea, and UAN are the same forms of nitrogen fertilizer currently used in agriculture.

Low-value feedstocks provide price-stability and predictability to the market for these fertilizer end products. Inbound shipping costs of feedstocks are eliminated because the feedstocks are already onsite at the ethanol plants. Substantially reduced outbound costs of the fertilizer products are realized in the agricultural market because these three fertilizer end products can be shipped directly from a local ethanol plant to local farms. Reduced environmental emissions are realized due to less carbon dioxide and carbon monoxide being released to the atmosphere, and less fossil fuel is needed at the ethanol plant due to recovery of heat from the exothermic reactions occurring during the fertilizer production process.

Fertilizer production plant 12 is located next to ethanol plant 10. Dried corn fiber and clean CO2 are provided by ethanol plant. The corn fiber is delivered from ethanol plant 10 to storage bins 14, from which the corn fiber can be supplied on demand to fertilizer production system 12. CO2 can be sent directly from the ethanol plant with no surge capacity provided. Any interruption in CO2 due to upsets at the ethanol plant will cause an interruption in production of urea.

Utilities such as cleaning solutions, compressed instrument air, steam and cooling tower water can be provided by ethanol plant 10. This integration and shared utilities reduces the capital expense required for the installation and operation of the fertilizer production system 12.

Ammonia Production

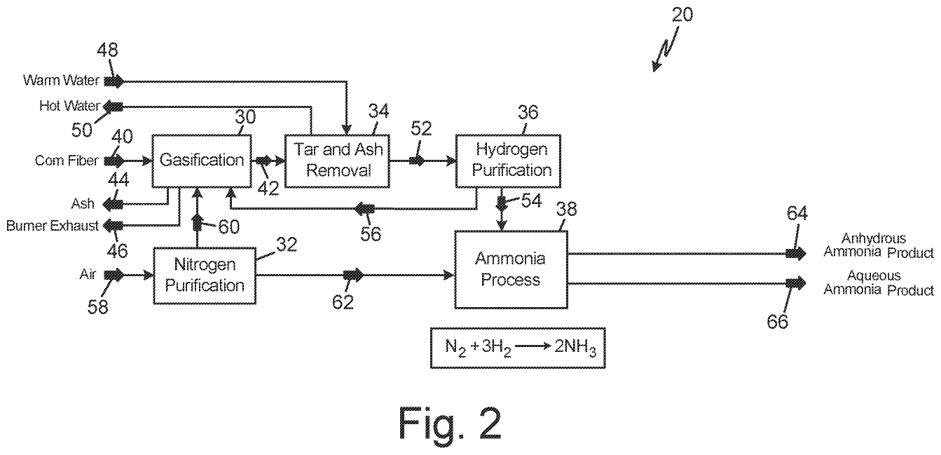

FIG. 2 is a flow diagram of fertilizer production plant 12 for production of ammonia products (anhydrous ammonia and aqueous ammonia). Fertilizer production plant 12 includes gasifier 30, pressure swing adsorption (PSA) separator 32, liquid scrubber 34, hydrogen purifier 36, and ammonia reactor 38. FIG. 2A also shows the following flow streams: corn fiber stream 40, syngas (synthesis gas) stream 42, ash stream 44, burner exhaust stream 46, warm water stream 48, hot water stream 50, clean gas stream 52, hydrogen product stream 54, waste hydrogen 56, air stream 58, waste nitrogen stream 60, nitrogen product stream 62, anhydrous ammonia product stream 64, and aqueous ammonia product stream 66.

Fertilizer production begins with pulling corn fiber from storage bins 14 to feed gasifier system 30. Corn fiber stream 40 is finely ground corn fiber at 10% moisture. Gasifier 30 includes an enclosed conveyor that transfers corn fiber stream 40 through a heated zone that is run at 1200° F. The heated zone will be kept low in oxygen where synthesis gas (syngas), carbon monoxide and hydrogen, are driven off the solids (corn fiber).

Water is added to allow the carbon monoxide to be converted to carbon dioxide and hydrogen to maximize the production of hydrogen.

Nitrogen is produced from atmospheric air. Air will be compressed to 5 psig, filtered and then cooled to 100 F before being sent to a series of PSA separators that will be used to selectively produce a high purity nitrogen stream. Gasifier 30 will be run inefficiently to allow for the production of high quality nitrogen allowing more nitrogen to leave with the off gas stream.

Nitrogen is produced at high quality and low pressure. This gas is fed to a compressor at ammonia reactor 38, where it is heated and then fed to catalyst beds along with compressed hydrogen.

Waste nitrogen stream 60 from nitrogen purifier 32 will be sent through gasifier 30 to push the syngas stream 42 through the system. Syngas produced in the heated zone will exit the gasifier 30 and will be passed through liquid scrubber 34 where ash and tar will be removed from the syngas leaving mostly clean syngas consisting of hydrogen and carbon dioxide.

Water from the bottom of liquid scrubber 34 is cooled through a recirculation cooler and sent back to the top of the liquid scrubber 34. Cool water will cool and condense the tars in syngas stream 42, capturing these materials, and capturing any solids materials present in the crude syngas stream. A portion of the water will be blown down to allow for the removal of these captured components. The dirty water stream will be sent to ethanol plant 10 to be incorporated into the plant evaporation system and leaving the plant as part of the DDGS feed. Clean cool syngas is fed to a compressor and passed through PSA system 32 where hydrogen is selectively removed from the gas stream.

PSA separator 32 can be run inefficiently, producing a cleaner hydrogen product, and allowing some hydrogen to leave the system in the waste off gas. Waste off gas will be sent to the burner used to provide heat to gasifier 30 or to the boiler of ethanol plant 10, where the gas will be used to reduce the amount of natural gas used in the ethanol distillation process.

High quality hydrogen stream 54 from hydrogen purifier 36 and high quality nitrogen stream 62 from PSA separator 32 are fed directly to the ammonia reactor 38 where it will be compressed, heated and sent through the catalyst beds. Hydrogen and nitrogen stream are fed to catalyst bed reactors that will contain catalysts and will be run at 850° F. and 3600 psig. Each pass through the catalyst bed will partially convert the syngas to ammonia which will require a separation process where Ammonia is separated from the unreacted syngas, and the syngas is recycled back to the reactor or sent to another reactor in series. In this example, the ammonia process is the Haber-Bosch process. An example of the catalyst is ruthenium-calcium-aluminum metal catalyst. In the event the ammonia system does not require as much hydrogen as produced by the gasifier 30 and PSA gas separator 32, excess hydrogen will be vented to the burner on gasifier 30.

Residual solids from the gasifier 30 will leave system 20 as dry ash stream 44 that will be cooled, collected and landfilled. It may be possible to sell this product as a fertilizer.

Urea Production

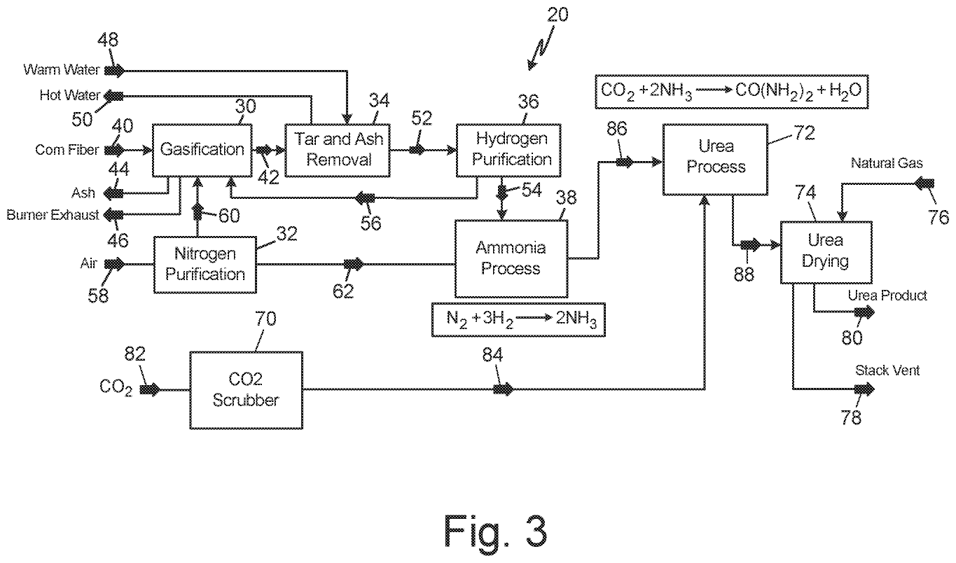

FIG. 3 is a flow diagram of fertilizer production system 20 configured for production of urea product. In this configuration, system 20 includes gasifier 30, PSA separator, liquid scrubber 34, hydrogen purifier 36, and ammonia reactor 38 as well as flow streams 40, 42, 44, 46, 48, 50, 52, 54, 56, 58, 60, and 62 as shown in FIG. 2. In addition, flow diagram includes CO2 scrubber 70, urea reactor 72, urea dryer 74, natural gas stream 76, stack vent 78, urea product 80, CO2 feed stream 82, CO2 product stream 84, ammonia product stream 86, and urea product stream 88.

Urea production involves reacting CO2 from CO2 product stream 84 and ammonia product stream in urea processor 72 at 3600 psig and 400 F. Unreacted CO2 and ammonia are recovered, compressed and returned to urea reactor 72.

Urea product stream 88 is recovered in the form of a 70% solution of urea, which is evaporated to a molten form of urea at 270 F. This molten urea is fed to urea dryer 74 that sprays and cools the molten urea to produce small particle dried urea. The urea particles can be in the form of prills. Alternatively, it can be in the form of diesel exhaust fluid.

UAN Production

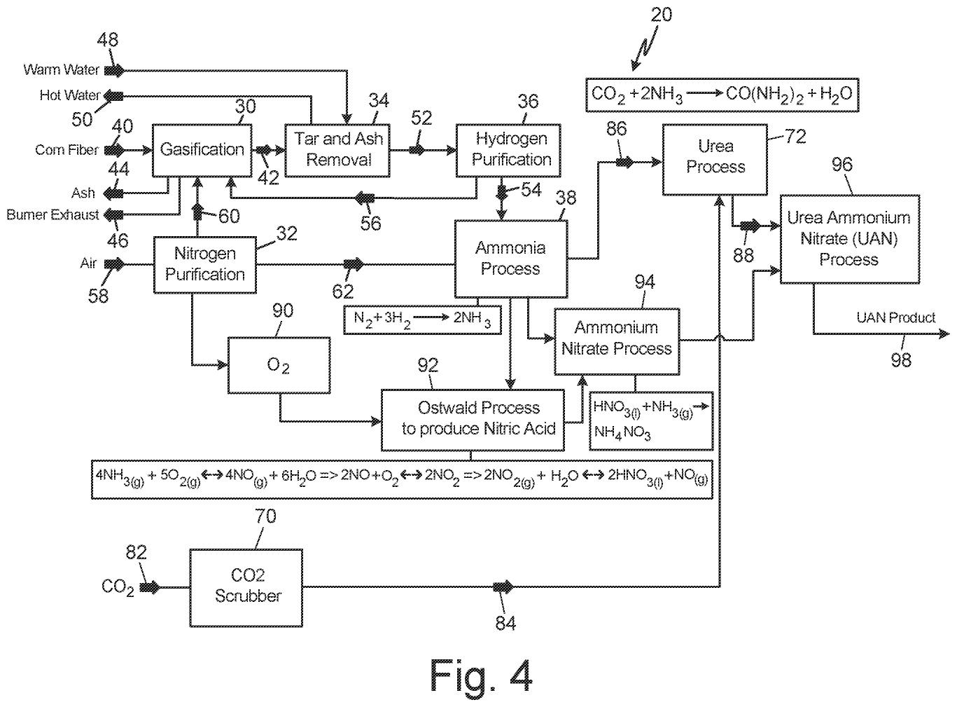

FIG. 4 is a flow diagram of fertilizer production system 20 configured for production of urea ammonium nitrate (UAN) product. In this configuration, system 20 includes gasifier 30, PSA separator 32, liquid scrubber 34, hydrogen purifier 36, ammonia reactor 38, flow streams 40, 42, 44, 46, 48, 50, 52, 54, 56, 58, 60, and 62, CO2 scrubber 70, urea reactor 72, CO2 feed stream 82, CO2 product stream 84, ammonia product stream 86, and urea product stream 88. In addition, the flow diagram includes oxygen reservoir 90, Ostwald processor 92, ammonium nitrate processor 94, urea ammonium nitrate (UAN) processor 96, and UAN product 98.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment(s) disclosed, but that the invention will include all embodiments falling within the scope of the appended claims.

1. A method of manufacturing an agricultural fertilizer product, the method comprising:
feeding corn fiber into a gasifier;
heating the corn fiber in the gasifier to produce synthesis gas containing hydrogen;
purifying the synthesis gas to produce a hydrogen flow stream;
feeding ambient air into a pressure swing adsorption (PSA) separator to produce a nitrogen flow stream;
reacting the hydrogen flow stream and the nitrogen flow stream in a catalyst bed reactor to produce ammonia.

2. The method of claim 1, wherein the ammonia comprises an anhydrous ammonia product.

3. The method of claim 1, wherein the ammonia comprises an aqueous ammonia product.

4. The method of claim 1, wherein reacting the hydrogen flow stream and the nitrogen flow stream is performed by a Haber-Bosch process.

5. The method of claim 1, and further comprising:
feeding ammonia from the catalyst be reactor to an urea reactor;
delivering a carbon dioxide feed stream to the urea reactor; and
reacting the ammonia and the carbon dioxide in the urea reactor to produce urea.

6. The method of claim 5 and further comprising drying the urea to form a dry urea fertilizer product.

7. The method of claim 5, wherein the corn fiber and the carbon dioxide are produced in an ethanol plant.

8. The method of claim 7, wherein the ethanol plant is co-located with a fertilizer processing plant.

9. The method of claim 5 and further comprising:
reacting oxygen separated by the PSA separator and ammonia from the ammonia reactor to produce ammonium nitrate; and
combining urea from the urea reactor with the ammonium nitrate to produce a urea ammonium nitrate (UAN) fertilizer product.
